(19) United States
(12) Patent Application Publication
(10) Pub. No.: US 2020/0138068 A1
(43) Pub. Date: May 7, 2020

(54) Snack Food Manufacture

(71) Applicant: Frito-Lay Trading Company GMBH, Berne (CH)

(72) Inventors: Michael Alfred James SPURR, Leicester (GB); Rachael ALLEN, Leicester (GB); John Richard BOWS, Leicester (GB); Bruce R. LINTER, Leicester (GB); David HART, Norwich (GB); Paul Antony KROON, Norwich (GB)

(21) Appl. No.: 16/628,761

(22) PCT Filed: Jul. 5, 2018
(86) PCT No.: PCT/EP2018/068225

§ 371 Date: Jan. 6, 2020

(30) Foreign Application Priority Data
Jul. 7, 2017 (GB) 1710980.2

(51) Int. Cl. A23L 19/18; A21D 13/043; A21D 2/36

(52) U.S. Cl. CPC A23L 19/19; A23V 2002/00; A21D 2/36; A21D 13/043

(57) ABSTRACT

A method of making a snack food in the form of snack food chips, the method comprising the steps of: a. providing at least one pre-processed vegetable material, the pre-processed vegetable material including at least one bioactive component which comprises a polyphenol or a glucosinolate or a mixture of any two or more thereof, wherein the at least one pre-processed vegetable material is in a freeze-dried form, in an individually quick frozen (IQF) form, in a defrosted, chilled or fresh comminuted form and/or in a defrosted, chilled or fresh pulp form; b. incorporating the at least one pre-processed vegetable material into a dough, wherein the dough is a potato-based dough, and wherein the dough forms individual dough sheet portions, and the snack food is in the form of snack food chips; c. cooking the dough sheet portions to form a cooked snack food in the form of snack food chips, the cooked snack food having a moisture content after the cooking step of from 5 to 25 wt % based on the weight of the cooked snack food, wherein the cooking comprises baking, microwave cooking, infrared cooking or radio frequency (RF) cooking; and d. drying the cooked snack food to form a dried snack food which has a moisture content after the drying step of from 1 to 4 wt %, based on the weight of the dried cooked snack food.

### BACKGROUND OF THE INVENTION

### Field of the Invention

The present invention relates to a method of making a snack food and to a snack food chip.

### Description of the Prior Art

Increased consumption of fruit and vegetables are important public health goals that have been recommended by nutritionists and medical experts as a key component of a healthy diet for the prevention of chronic diseases such as cardiovascular disease and cancer. However, despite their benefits, the majority of the population in affluent and developing countries still do not consume the recommended five servings of fruit and vegetables per day. It is therefore important that new approaches are found to increase the population's vegetable consumption. At the same time, rising awareness of the problems derived from inadequate diet translates into an increasing demand from consumers and policy makers for healthier alternatives to the traditional products.

In the UK, average fruit and vegetable consumption remains significantly below the government's recommended target of five portions per day. Innovative ways of incorporating vegetables into existing popular foods and snacks is a potential route for increasing vegetable consumption.

Many consumers eat snack foods, such as snack chips. There is a general need in the snack food art to provide consumers with more nutritious products. There is a general need for the nutritional value and potential health benefits of snack food products, such as potato based snacks, to be increased. Whilst in theory, snack foods could be made more nutritious by the incorporation of nutrients or bioactives into the ingredients of the snack food recipe, unfortunately, in practice it has been found that bioactives incorporated into food products tend to be lost during the processing and manufacturing steps. Processing factors like temperature, pressure, moisture, and mixing, for example, are believed to have a critical effect on the stability of the bioactive components during manufacture of the snack food, and the capacity of resultant snack food to instigate health benefits when consumed. It is necessary not only to provide bioactive component in the original ingredient recipe, but also to provide the bioactive component in bioavailable form so that when the snack food is consumed by the human body, the bioactive component is bioavailable within the body.

Polyphenols are well known bioactives with an important antioxidant and anti-inflammatory activity. It has been widely reported that an increased consumption of these compounds is associated with a reduced risk of cardiovascular disease, stroke, arthritis, inflammatory bowel diseases, and some cancers. Therefore, the inclusion of polyphenols in the formulation of snack food products would be desirable to increase the nutritional value of such products.

There is therefore a need for a method of making snack foods, and a resultant snack food, which can provide the snack food with the functional property of comprising bioactive components in a bioavailable form, for example polyphenols, so that the bioactive components can be released within the human body after consumption of the snack food.

The present invention aims at least partially to meet those needs. The present invention aims to provide a snack food, and a method of manufacture of snack food, which can provide the snack food with high nutritional content, in particular a high content of at least one bioactive.

### SUMMARY OF THE INVENTION

The present invention accordingly provides a method of making a snack food in the form of snack food chips, method of making a snack food in the form of snack food chips, the method comprising the steps of:

a. providing at least one pre-processed vegetable material, the pre-processed vegetable material including at least one bioactive component which comprises a polyphenol or a glucosinolate or a mixture of any two or more thereof, wherein the at least one pre-processed vegetable material is in a freeze-dried form, in an individually quick frozen (IQF) form, in a defrosted, chilled or fresh comminuted form and/or in a defrosted, chilled or fresh pulp form;
b. incorporating the at least one pre-processed vegetable material into a dough, wherein the dough is a potato-based dough, and wherein the dough forms individual dough sheet portions, and the snack food is in the form of snack food chips;
c. cooking the dough sheet portions to form a cooked snack food in the form of snack food chips, the cooked snack food having a moisture content after the cooking step of from 5 to 25 wt % based on the weight of the cooked snack food, wherein the cooking comprises baking, microwave cooking, infra-red cooking or radio frequency (RF) cooking; and
d. drying the cooked snack food to form a dried snack food which has a moisture content after the drying step of from 1 to 4 wt %, based on the weight of the dried cooked snack food.

The present invention further provides a snack food chip comprising vegetable material including at least one bioactive component which comprises a polyphenol or a glucosinolate or a mixture of any two or more thereof, wherein the at least one bioactive component is present in a concentration of at least 5 mg per 100 g of the snack food chip on a dry material basis.

The present invention further provides the use of at least one pre-processed vegetable material, the pre-processed vegetable material including at least one bioactive component which comprises a polyphenol or a glucosinolate or a mixture of any two or more thereof, wherein the at least one pre-processed vegetable material is in a freeze-dried form, in an individually quick frozen (IQF) form, in a defrosted, chilled or fresh comminuted form or in a defrosted, chilled or fresh pulp form, in the manufacture of cooked snack food for increasing the concentration of the bioactive component in the cooked snack food.

The present invention further provides the use of at least one pre-processed vegetable material, the pre-processed vegetable material including at least one bioactive component which comprises a polyphenol or a glucosinolate or a mixture of any two or more thereof, wherein the at least one pre-processed vegetable material is in a freeze-dried form, in an individually quick frozen (IQF) form, in a defrosted, chilled or fresh comminuted form or in a defrosted, chilled or fresh pulp form, in the manufacture of cooked snack food in the manufacture of cooked snack foods for maintaining the bioavailability of the bioactive component after human consumption of the cooked snack food.

Preferred features of all of these aspects of the present invention are defined in the respective dependent claims.

The preferred embodiments of the present invention can provide a method of making a snack food in the form of a snack food chip which can provide the technical effect that significant quantities of vegetables can be incorporated into the snack food chip with good retention of bioactives and that the bioavailability of the bioactive compounds is similar to that for the equivalent cooked vegetables. Simulated in-vitro digestion tests carried out by the inventors have shown that a substantial release of quercetin and apigenin, and some release of glucoraphanin, can be achieved from the snack food produced according to the present invention. In humans, the bioavailability of quercetin, apigenin and glucoraphanin was found to be similar after consumption of the snack or steamed vegetables.

The preferred embodiments of the present invention can prepare a potato-based snack, for example in the form of a baked chip, containing significant quantities of vegetables that are rich sources of bioactives that are considered to provide health benefits. The preferred embodiments of the present invention particularly use freeze-dried vegetables which facilitates a high vegetable dry matter incorporation rate into the snack food, and can give a higher vegetable content for a given mass of meal than, for example, oven baked snack food chips made using a dough incorporating wet vegetables or instant quick frozen (IQF) vegetables that have been steamed and microwaved. The preferred process uses oven baking to cook a dough and produce the final snack food product, typically a chip.

The preferred embodiments of the present invention can provide that the use of freeze-dried vegetables to produce a snack food can produce a snack food with a very high content of bioactive, in particular for a bioactive component which comprises a polyphenol, such as a flavanol or a flavone, or a glucosinolate.

### BRIEF DESCRIPTION OF THE DRAWINGS

Embodiments of the present invention will now be described by way of example only with reference to the accompanying drawings, in which:

FIG. 1 schematically illustrates a process flow of a method of making a snack food in accordance with an embodiment of the present invention.

### DETAILED DESCRIPTION OF THE EMBODIMENTS OF THE INVENTION

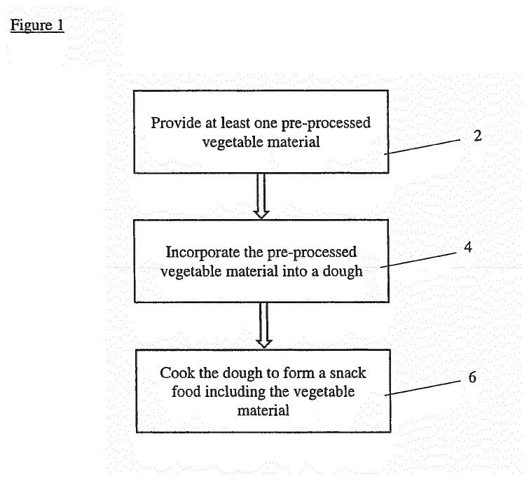

Referring to FIG. 1 of the accompanying drawings, an embodiment of a method of making a snack food is schematically illustrated.

The method of making a snack food comprises a first step 2 of providing at least one pre-processed vegetable material. The pre-processed vegetable material includes at least one bioactive component which comprises a polyphenol or a glucosinolate or a mixture of any two or more thereof. The at least one pre-processed vegetable material is in a freeze-dried form, in an individually quick frozen (IQF) form, in a defrosted, chilled or fresh comminuted form and/or in a defrosted, chilled or fresh pulp form.

In a preferred embodiment, the at least one pre-processed vegetable material comprises at least one freeze-dried vegetable or herb which is preferably prepared by (i) subjecting a fresh vegetable or herb to an individually quick frozen (IQF) process to provide the vegetable or herb in an individually quick frozen (IQF) form; and then (ii) freeze-drying the vegetable or herb in the individually quick frozen (IQF) form to provide the vegetable or herb in the freeze-dried form. Preferably, the freeze-dried vegetable or herb is in the form of a dry powder.

In an alternative preferred embodiment, the at least one pre-processed vegetable material comprises at least one individually quick frozen (IQF) vegetable or herb. Preferably, the individually quick frozen (IQF) vegetable or herb is in the form of comminuted particles.

In some preferred embodiments, the at least one pre-processed vegetable material comprises a mixture of at least one freeze-dried vegetable or herb and at least one individually quick frozen (IQF) vegetable or herb.

In a second step 4, the at least one pre-processed vegetable material is incorporated into a dough.

The dough is a potato-based dough typically comprising from 10 to 80 wt %, optionally from 15 to 50 wt %, further optionally from 20 to 40 wt %, potato on a dry material basis. Optionally, in the potato-based dough the potato is provided in the form of dried potato, optionally potato flakes.

Typically, the dough further comprises (i) from 5 to 25 wt %, optionally from 10 to 20 wt %, waxy starch, optionally waxy maize starch, on a dry material basis; (ii) from 0.5 to 2 wt %, optionally from 0.75 to 1.25 wt %, of an emulsifier, optionally lecithin, on a dry material basis; and (iii) from 0.5 to 2 wt %, optionally from 0.75 to 1.25 wt %, of a vegetable oil, optionally sunflower oil, further optionally a high-oleic acid sunflower oil (HOSO), on a dry material basis. Other ingredients may be optionally added, such as flavourings and seasonings.

Typically, the dough has a moisture content of from 25 to 90 wt %, optionally from 25 to 50 wt %, further optionally from 35 to 45 wt %, based on the weight of the dough.

The dough forms individual dough sheet portions, so that the resultant snack food is in the form of snack food chips. Preferably, the individual dough sheet portions are fully or partly cut from a dough sheet. Alternatively, the individual dough sheet portions may be made by rotary forming, stamping or moulding. The individual dough sheet portions may be interconnected by bridge portions to avoid inadvertent slippage of the individual dough sheet portions from a conveyor during cooking or drying, or during any other conveying operation.

In a third step 6, the dough is cooked to form a snack food. The cooked snack food has a moisture content after the cooking step of from 5 to 20 wt %, optionally from 7.5 to 15 wt %, based on the weight of the cooked snack food.

In some embodiments, the cooking comprises a first step in which a single layer of dough is cooked and dried to a first moisture content to form a partly cooked food slice and a second step in which a bed comprising a stack of a plurality of the partly cooked food slices is dried from the first moisture content to a lower second moisture content. The first step may be carried out through a single oven or a series of ovens and each oven may be controlled to provide respective predetermined drying rate therein.

After the cooking step the cooked snack food is subjected to a drying step, and the dried snack food has a moisture content after the drying step of from 1 to 4 wt %, optionally from 2 to 3 wt %, based on the weight of the dried cooked snack food. Optionally, the drying step is carried out on a bed comprising a stack of a plurality of cooked snack food slices.

Typically, the cooking step has a moisture removal rate of from 1×10⁻³ to 10×10⁻³ g water/g solids/sec, and/or the drying step has a moisture removal rate of from 1×10⁻⁵ to 10×10⁻⁴ g water/g solids/sec, and/or the average moisture removal rate during the combination of the cooking and drying steps is from 1×10⁻⁴ to 10×10⁻⁴ g water/g solids/sec.

In some preferred embodiments, the cooking comprises baking, optionally baking in an impingement oven.

The baking process may be used when the dough comprises freeze dried and/or individually quick frozen (IQF) vegetable or herb, for example (i) a mixture of at least one freeze-dried vegetable or herb and at least one individually quick frozen (IQF) vegetable or herb, or (ii) at least one individually quick frozen (IQF) vegetable or herb.

The baking may be carried out at an oven temperature within the range of from 120 to 320° C. for a period of from 60 to 600 seconds, preferably at an oven temperature within the range of from 150 to 225° C. for a period of from 60 to 90 seconds.

The baking process uses an impingement oven which typically comprises a plurality of cooking zones, with each zone being individually controllable with regard to temperature and air flow.

For example, a two zone oven may be used having zones 1 and 2 as serial zones between an input and output, with zone 1 set at a cooking temperature of 195° C. and zone 2 set at a cooking temperature of 175° C., and the total residence time in the oven being from 60 to 90 seconds, for example about 78 seconds.

Such a cooking protocol reduces the moisture content of the dough, typically from an initial 40 wt % to an exit value of from 10 to 15 wt %, for example about 11.5 wt %. The moisture removal rate during cooking is typically from 6×10⁻³ to 8×10⁻³ g water/g solids/sec, for example about 6.9×10⁻³ g water/g solids/sec.

After exiting the oven, the cooked dough is conveyed into a secondary oven, which is a deep bed dryer, which typically has a drying temperature of from 100 to 125° C., such as 115° C., and a residence time of from 600 to 1200 seconds, such as about 900 seconds.

Such a drying protocol further reduces the moisture content of the dough, typically to a final moisture content of about 2.5 wt %. The moisture removal rate during drying is typically from 1×10⁻⁴ to 2×10⁻⁴ g water/g solids/sec, for example about 1.2×10⁴ g water/g solids/sec.

The average moisture removal rate during the combination of the cooking and drying steps is typically from 5×10⁻⁴ to 8×10⁴ g water/g solids/sec, for example about 6.6×10⁻⁴ g water/g solids/sec.

In some alternative preferred embodiments, the cooking comprises microwave cooking, infra-red cooking or radio frequency (RF) cooking. The microwave cooking process may be used when the dough comprises freeze dried and/or individually quick frozen (IQF) vegetable or herb, for example any mixture of at least one freeze-dried vegetable or herb and at least one individually quick frozen (IQF) vegetable or herb.

The microwave cooking process uses a microwave oven which typically heats at least the external surface of the dough to a temperature of at least 100° C. and has a residence time in the microwave oven of from 60 to 600 seconds, optionally from 200 to 400 seconds, for example about 270 seconds. The microwave cooking step may precede a baking step as described above.

Such a microwave cooking protocol reduces the moisture content of the dough, typically from an initial 40 wt % to an exit value of from 10 to 15 wt %, for example about 11.5 wt %. The moisture removal rate during microwave cooking is typically from 1×10⁻³ to 3×10⁻³ g water/g solids/sec, for example about 2.2×10⁻³ g water/g solids/sec.

After exiting the oven, the cooked dough is conveyed into a secondary oven, which is a deep bed dryer, which typically has a drying temperature of from 100 to 125° C., such as 115° C., and a residence time of from 600 to 1200 seconds, such as about 900 seconds.

Such a drying protocol further reduces the moisture content of the dough, typically to a final moisture content of about 2.5 wt %. The moisture removal rate during drying is typically from 6×10⁻⁵ to 8×10⁻⁵ g water/g solids/sec, for example about 6.8×10⁻⁵ g water/g solids/sec.

The average moisture removal rate during the combination of the microwave cooking and drying steps is typically from 5×10⁴ to 8×10⁻⁴ g water/g solids/sec, for example about 5.5×10⁻⁴ g water/g solids/sec.

As stated above, the pre-processed vegetable material includes at least one bioactive component which comprises a polyphenol or a glucosinolate or a mixture of any two or more thereof. In some preferred embodiments, the polyphenol comprises a flavanol or a flavone.

For example, the at least one pre-processed vegetable material may include a bioactive component which comprises a flavanol and comprises a vegetable or herb selected from onion, red onion, spring onion, capers, capsicum pepper, serrano pepper, chilli pepper, hot wax pepper, ancho pepper, fennel, radish, radicchio, kale, chive, dill, lovage, sorrel, coriander, tarragon, watercress, corn poppy, buckwheat, or sweet potato, or any mixture of any two or more thereof. In particularly preferred embodiments, the flavanol is quercetin, which is particularly present in onion, as well as other vegetable and herbs as listed above.

Typically, the dough comprises from 2 to 50 wt %, optionally from 3 to 25 wt %, of the at least one pre-processed vegetable material, which includes a bioactive component which comprises a flavanol, on a dry material basis. Typically, the dough comprises from 20 to 100 mg, optionally from 30 to 50 mg, of the flavanol per 100 g of the dough on a dry material basis. Typically, the at least one pre-processed vegetable material comprises from 200 to 400 mg of the flavanol per 100 g of the pre-processed vegetable material on a dry material basis.

After the cooking step 6, the snack food preferably comprises from 20 to 100 mg, optionally from 30 to 50 mg, of the flavanol per 100 g of the snack food on a dry material basis.

In other examples, the at least one pre-processed vegetable material includes a bioactive component which comprises a flavone and comprises a vegetable or herb selected from artichoke, celery, celeriac, spinach, basil, coriander, oregano, parsley, rosemary, or thyme, or any mixture of two or more thereof. In particularly preferred embodiments, the flavone is apigenin, which is particularly present in parsley, as well as other vegetable and herbs as listed above. In particularly preferred embodiments, the flavone is apigenin, which is particularly present in parsley, as well as other vegetable and herbs as listed above.

Typically, the dough comprises from 2 to 50 wt %, optionally from 3 to 25 wt %, of the at least one pre-processed vegetable material, which includes a bioactive component which comprises a flavone, on a dry material basis. Typically, the dough comprises from 10 to 150 mg, optionally from 30 to 50 mg, of the flavone per 100 g of the dough on a dry material basis. Typically, the at least one pre-processed vegetable material comprises from 500 to 2000 mg of the flavone per 100 g of the pre-processed vegetable material on a dry material basis.

After the cooking step 6, the snack food preferably comprises from 15 to 150 mg, optionally from 30 to 50 mg, of the flavone per 100 g of the snack food on a dry material basis.

In other examples, the at least one freeze-dried vegetable includes a bioactive component which comprises a glucosinolate and is selected from brussels sprout, cabbage, savoy cabbage, red cabbage, kale, kohlrabi, pakchoi, horseradish, wasabi, broccoli, cauliflower, turnip, watercress, green mustard, or cress, or any mixture of any two or more thereof. In particularly preferred embodiments, the glucosinolate is glucoraphanin, which is particularly present in broccoli, as well as other vegetable and herbs as listed above.

Typically, the dough comprises from 2 to 50 wt %, optionally from 3 to 25 wt %, of the at least one pre-processed vegetable material, which includes a bioactive component which comprises a glucosinolate, on a dry material basis. Typically, the dough comprises from 10 to 75 mg, optionally from 15 to 50 mg, of the glucosinolate per 100 g of the dough on a dry material basis. Typically, the at least one pre-processed vegetable material comprises from 100 to 500 mg of the glucosinolate per 100 g of the pre-processed vegetable material on a dry material basis.

After the cooking step 6, the snack food preferably comprises from 10 to 75 mg, optionally from 15 to 50 mg, of the glucosinolate per 100 g of the snack food on a dry material basis.

After the cooking step 6 to form the snack food, the at least one bioactive component, which comprises a polyphenol or a glucosinolate or a mixture of any two or more thereof, in the snack food has bioavailability after human consumption of the snack food. Typically, polyphenol or glucosinolate or mixture of any two or more thereof is present in a concentration of at least 5 mg per 100 g of the snack food on a dry material basis.

The method of the present invention can preferably produce a snack food which comprises at least one of (i) from 20 to 100 mg, optionally from 30 to 50 mg, of a flavanol polyphenol per 100 g of the snack food snack food on a dry material basis; (ii) from 15 to 150 mg, optionally from 30 to 50 mg, of the flavone polyphenol per 100 g of the snack food on a dry material basis; and/or (iii) from 10 to 75 mg, optionally from 15 to 50 mg, of the glucosinolate per 100 g of the snack food on a dry material basis.

Accordingly, the method of the present invention can provide a snack food chip comprising vegetable material including at least one bioactive component which comprises a polyphenol or a glucosinolate or a mixture of any two or more thereof, wherein the at least one bioactive component is present in a concentration of at least 5 mg per 100 g of the snack food chip on a dry material basis.

In an embodiment in which the bioactive component comprises a flavanol, such as quercetin, the flavanol may be present in an ingredient which comprises a vegetable or herb selected from onion, red onion, spring onion, capers, capsicum pepper, serrano pepper, chilli pepper, hot wax pepper, ancho pepper, fennel, radish, radicchio, kale, chive, dill, lovage, sorrel, coriander, tarragon, watercress, corn poppy, buckwheat, or sweet potato, or any mixture of any two or more thereof. The snack food snack food chip preferably comprises from 20 to 100 mg, optionally from 30 to 50 mg, of the flavanol per 100 g of the snack food snack food chip on a dry material basis.

In an embodiment in which the bioactive component comprises a flavone, such as apigenin, the flavone is present in an ingredient which comprises a vegetable or herb selected from artichoke, celery, celeriac, spinach, basil, coriander, oregano, parsley, rosemary, or thyme, or any mixture of two or more thereof. The snack food chip preferably comprises from 15 to 150 mg, optionally from 30 to 50 mg, of the flavone per 100 g of the snack food chip on a dry material basis.

In an embodiment in which the bioactive component comprises a glucosinolate, such as glucoraphanin, the glucosinolate is present in an ingredient which comprises a vegetable or herb selected from brussels sprout, cabbage, savoy cabbage, red cabbage, kale, kohlrabi, pakchoi, horseradish, wasabi, broccoli, cauliflower, turnip, watercress, green mustard, or cress, or any mixture of any two or more thereof. The snack food chip preferably comprises from 10 to 75 mg, optionally from 15 to 50 mg, of the glucosinolate per 100 g of the snack food chip on a dry material basis.

Accordingly, the method of the present invention provides the use of at least one pre-processed vegetable material, the pre-processed vegetable material including at least one bioactive component which comprises a polyphenol or a glucosinolate or a mixture of any two or more thereof, in the manufacture of cooked snack food for increasing the concentration of the bioactive component in the cooked snack food, and/or maintaining the bioavailability of the bioactive component after human consumption of the cooked snack food. In such a use the at least one pre-processed vegetable material is in a freeze-dried form, in an individually quick frozen (IQF) form, in a defrosted, chilled or fresh comminuted form or in a defrosted, chilled or fresh pulp form.

The present invention will now be described further with reference to the following non-limiting Examples.

### Examples 1 to 4 and Comparative Example 1

In these Examples and Comparative Example, the retention, bioaccessibility and bioavailability of various vegetable bioactives after incorporation into a baked snack, in accordance with Examples 1 to 4, or after steaming, in accordance with Comparative Example 1, were investigated. In particular, vegetables/herbs containing the bioactives quercetin, apigenin and glucoraphanin were incorporated into a processed snack food and the bioaccessibility and bioavailability of these bioactives were assessed before and after consumption. These were compared against steamed/microwaved frozen vegetables. Different processing routes were considered for production of snacks containing relevant quantities of bioactives, using individually quick frozen or freeze-dried vegetables/herbs.

In particular, three selected vegetables/herbs containing plant bioactives with potential health benefits were incorporated as dry ingredients in the preparation of a processed snack food. The vegetable/herbs were selected to represent different types of bioactives of nutritional interest such as glucoraphanin from broccoli, quercetin, a flavanol from onion, and apigenin, a flavone from parsley.

In these Examples, a snack food was produced by mixing freeze-dried vegetables and an IQF herb with additional ingredients. In these Examples, the dough was a potato-based dough, including potato flakes, starch, sugar, lecithin, high oleic oil and water, to form a dough which was then baked. The potato-based dough comprised from 15 to 50 wt % potato on a dry material basis. The potato was provided in the form of dried potato, in particular potato flakes. The dough further comprised (i) from 5 to 25 wt %, waxy starch, optionally waxy maize starch, on a dry material basis; (ii) from 0.5 to 2 of an emulsifier, in particular lecithin, on a dry material basis; and (iii) from 0.5 to 2 wt %, of a high-oleic acid sunflower oil (HOSO), on a dry material basis. A minor amount of sugar was added as a flavouring. The resultant chip was optionally topically seasoned after cooking.

Typically, the dough has a moisture content of from 25 to 90 wt %, optionally from 25 to 50 wt %, further optionally from 35 to 45 wt %, based on the weight of the dough.

In particular, freeze-dried onion and broccoli and IQF parsley were mixed with potato flakes, starch, sugar, lecithin, high oleic oil and water to form a dough which was then sheeted and baked in an impingement oven, using the cooking protocol described above, and then dried, using the drying protocol described above, to form snack food chips. The dough moisture content was 40+/−2 wt %, and the dough temperature was 24.5+/−1.5° C. The dough sheet was cut to form 50 mm diameter dough portions, each dough portion being approximately 1.8 g in weight. After baking in the impingement oven, the chips had a moisture content of 11.5+/−1.5 wt %. After drying in a conventional snack chip dryer, the baked chips had a moisture content of 2.5+/−0.5 wt %.

Examples 1, 2, 3 and 4 used different initial amounts and ratios of the freeze-dried onion and broccoli and IQF parsley as shown in Table 1.

The initial mass in the dough, measured on the basis of mg/100 mg of dry matter, of each of the bioactives glucoraphanin from the freeze-dried broccoli, quercetin from the freeze-dried onion and apigenin from the IQF parsley was measured and the results are shown in Table 1. Subsequently, the final mass in the snack food chip, measured on the basis of mg/100 mg of dry matter, of each of the bioactives glucoraphanin, quercetin and apigenin was measured and the results are also shown in Table 1.

TABLE 1

| | Glucoraphanin - from broccoli | | Apigenin - from parsley | | Quercetin - from onions | |
|---|---|---|---|---|---|---|
| | (mg/100 g dry matter) | | (mg/100g dry matter) | | (mg/100 g dry matter) | |
| | Dough | Snack Chip | Dough | Snack Chip | Dough | Snack Chip |
| Example 1 Vegetable/ | 66.1 ± 4.3 | 54.1 ± 3.2 | 139.7 ± 6.2 | 138.9 ± 4.2 | 27.6 ± 1.0 | 27.5 ± 1.8 |
| herb ratio (wt %) | | | | | | |
| Broccoli:onion:parsley | | | | | | |
| 44.6:13.4:7.5 | | | | | | |
| Example 2 Vegetable/ | 21.7 ± 1.8 | 22.4 ± 2.5 | 12.1 ± 1.0 | 13.0 ± 1.5 | 43.9 ± 1.7 | 49.4 ± 1.6 |
| herb ratio (wt %) | | | | | | |
| Broccoli:onion:parsley | | | | | | |
| 11.2:28.3:1.5 | | | | | | |
| Example 3 Vegetable/ | 18.6 ± 0.9 | 17.3 ± 0.8 | 14.3 ± 4.1 | 19.1 ± 0.2 | 36.1 ± 4.1 | 47.2 ± 2.1 |
| herb ratio (wt %) | | | | | | |
| Broccoli:onion:parsley | | | | | | |
| 11.4:30:3.3 | | | | | | |
| Example 4 Vegetable/ | 19.7 ± 0.5 | 16.9 ± 0.4 | 38.3 ± 11.6 | 40.7 ± 4.9 | 39.5 ± 3.6 | 44.1 ± 1.3 |
| herb ratio (wt %) | | | | | | |
| Broccoli:onion:parsley | | | | | | |
| 10.5:27.6:5 | | | | | | |

The extraction and quantification of glucoraphanin in broccoli, dough and snacks was performed according to the methods explained in Saha et al., Isothiocyanate concentrations and interconversion of sulforaphane to erucin in human subjects after consumption of commercial frozen broccoli compared to fresh broccoli. Molecular Nutrition & Food Research; (2012), 56(12):1906-16. The extraction and quantification of flavonoids in onions and parsley, dough and snacks was performed following a method by Price et al., Effect of storage and domestic processing on the content and composition of flavanol glucosides in onion (Allium cepa); Journal of Food and Agricultural Chemistry; (1997), 45 (3), 938-942. As apigenin was found to be not stable in the samples analysed, with its unstable malonyl form converted to the apiosyl form along with some other minor species, apigenin-7-glucoside, the corresponding identified metabolites were included in the analysis as described in Hostetler et al., Effects of food formulation and thermal processing on flavones in celery and chamomile; Food Chemistry; (2013), 141(2), 1406-1411.

These results show that by using dry vegetable/herb ingredients, in particular freeze-dried or IQF ingredients, the originally-present bioactives were present in the final snack chip product at concentrations largely consistent with the relative quantity of the vegetable source that had been incorporated into the dough. These results therefore demonstrate that incorporation of freeze-dried or IQF vegetables or herbs allows the production of snacks containing substantial amounts of bioactives with a high level of retention of these bioactives during the processing and manufacturing steps of a snack food product.

As a comparison, the results of Example 4 were compared to the bioactive composition in a portion of the vegetables which had been subjected to a steaming process representing a conventional method for cooking vegetables, this being Comparative Example 1.

In particular, the snack chip prepared according to Example 4 with a vegetable ratio 10.5 wt % broccoli, 27.6 wt % onion and 5 wt was analysed and compared to a test meal prepared with the same ratio of frozen vegetables that were simply cut, mixed and microwaved for a total of 9.5 minutes, according to Comparative Example 1. A comparison of bioactives present in 75 g of the processed snack chip, representing a snack chip meal, and the equivalent amount in a cooked mixed vegetable meal (461 g vegetables) confirmed that both meals contained similar doses of bioactives at the levels required to be detected in the subsequent analysis of blood and urine samples. The results are shown in Table 2.

TABLE 2

| | Glucoraphanin | Apigenin | Quercetin |
|---|---|---|---|
| | (mg) | (mg) | (mg) |
| 75 g snack chips | 12.7 | 30.5 | 33.1 |
| (Example 4) | | | |
| 461 g Cooked | 12.6 | 48.2 | 30.9 |
| mixed vegetables | | | |
| (Comparative | | | |
| Example 1) | | | |

It can be seen that 75 g of the produced snack contained similar amounts of the glucororaphanin, apigenin and quercetin as 461 g of a microwaved meal of the mixed vegetables. These amounts are considered to exceed the dose of each bioactive that is safe, dietary relevant and sufficient to allow quantification of the bioactives and/or their metabolites in blood and urine samples using data from previously reported human bioavailability studies. The estimated minimum doses required for the bioavailability study were: quercetin-25 mg, apigenin-15 mg, glucoraphanin-5 mg for the analysis of plasma samples, and quercetin-5 mg, apigenin-10 mg, glucoraphanin-5 mg for the analysis of urine samples. These levels were exceeded with the consumption of the described meals.

The bioavailability and bioacessability of these bioactives in the snack food chips was then determined. In order to study the relative bioaccessibility (fraction available for absorption from the gut after consumption) and bioavailability (amount absorbed and reaching the peripheral circulation) of each bioactive, human and in vitro digestion studies were carried out for a snack prepared according to Example 4. The resulting snack product was analysed and compared to a test meal prepared with the same ratio of frozen vegetables that were simply cut, mixed and microwaved for a total of 9.5 minutes.

An in vitro simulated digestion test was performed using a Caco-2 cell as disclosed in Aherne et al., Plant Foods Hum Nutr, (2009) 64:250-256, but with a preliminary amylase digestion phase. The uptake and transport of quercetin and apigenin was explored in an in-vitro Caco-2 cell analysis. The Caco-2 cell model was used to assess if changes in the recipe and the way of processing the snack would affect the rate of absorption and the trans-epithelial transport of the flavonoid bioactives. First, the snack products generated by the different processing routes, were subjected to simulated stomach and small intestinal digestion which was allowed to go to completion and centrifuged to generate clear liquids. The total uptake of quercetin or apigenin by the cells was quantified as the sum of metabolites in the incubation medium, metabolites located in the cells and the aglycone found in the cells. The rate of uptake by the cells was calculated as: (metabolites in cells+aglycone in cells+metabolites in medium)/time.

A snack chip produced according to Example 1 was compared to a steamed/microwaved vegetable mixture of the same vegetable ratio using a steaming/microwaving process as described above. Additionally, a snack chip produced according to Example 4 was compared to a steamed/microwaved vegetable mixture of the same vegetable ratio using a steaming/microwaving process as described above. No significant differences in the rate of uptake of either quercetin or apigenin were seen between the snack food chip of Examples 1 and 4 and the respective matched vegetable mix digests.

The snack chip produced according to Example 4 was then subjected to an in vitro gastric-duodenal digestion test. To simulate the oral phase in the digestion of a meal the protocol described in a consensus static method (Minekus et al., Food and Function (2014), 5, 1113) was followed. Mastication or chewing of the food was simulated by mixing all the components of the snack meal and mincing them with a manual mincer or by blending all the components of a corresponding cooked vegetable meal with a blender. Then, a simulated salivary fluid (SSF) was added. The gastric digestion of the meals was assessed using the dynamic gastric model (DGM) developed by Wickham et al; Dissolution Technologies (2012), 15. That process reproduces the inhomogeneous gastric mixing, antral shearing, and delivery rate to the duodenum with acidification and addition of gastric enzymes at a normal physiologic range replicating changes that occur in vivo. Meals coming from the oral phase were fed onto the DGM together with a drink of water in the presence of priming acid (20 ml). The food was processed in the DGM for the duration of 36 minutes, as calculated by the DGM model. The simulated gastric secretion, bile and pancreatic juice were prepared and added as reported (Pitino et al., Food Microbiology (2010), 8, 1121 and Mandalari et al., Journal of Agricultural and Food Chemistry (2008), 56, 3409). A pooled sample (239 gr for snack meals and 251 gr for veg mix meals) was transferred for duodenal digestion where simulated bile solution (30 ml for snack meals and 32 ml for vegetable meals respectively) and pancreatic enzyme solution (91 ml for snack meals and 95 ml for vegetable meals respectively) were added, and incubated at 37° C. under shaking conditions (170 rpm) for 8 hours.

The digestion of two meals containing similar quantities of bioactives were simulated to study the amount of each compound released from the food matrix and made accessible for absorption in the gastrointestinal tract over time (in vitro bioaccessibility). The meals consisted of (i) 75 gr snack chips according to Example 4 and 500 mL water (meal 1) or (ii) 461 g vegetable meal according to Comparative Example 1+20 ml water cooked in a microwave for 9.5 minutes and taken with 94 ml water (meal 2).

In this simulation stud, using the simulation developed by the Wickham et al (2012) reference cited above, the liquid fraction of a sample taken at different times from the simulated digestion were analysed to quantify the amount of each bioactive released to the aqueous phase at the time of removal indicating the progression in the release of bioactives throughout the in vitro digestion process. It was considered that the best way to estimate the bioaccessibility of the bioactives was by measuring directly their presence in the aqueous phase, which should correlate with loss from the solid phase. Results on the amount of each bioactive released to the liquid phase at the end of a simulated gastro-duodenal digestion are presented in Table 3.

TABLE 3

| | Apigenin | Quercetin | Glucoraphanin |
|---|---|---|---|
| | (mg) | (mg) | (mg) |
| Snack chips | 33.7 ± 1.6 | 10.0 ± 2.0 | 0.9 ± 0.3 |
| (Example 4) | | | |
| Cooked vegetables | 10.7 ± 0.3 | 6.3 ± 0.3 | 4.5 ± 2.1 |
| (Comparative | | | |
| Example 1) | | | |

There was a substantial release of quercetin and apigenin during digestion of both the snack chip meal and the vegetable meal (33.7 and 10 mg for apigenin and 10 and 6.3 mg for quercetin, respectively) indicating that both bioactives are bioaccessible. Glucoraphanin was also released from both food matrices but in higher amounts from the cooked vegetable meal (4.5 mg) compared to the snack chip meal (0.9 mg).

In a human study, the target population were apparently healthy adults (≥18 years), who were non-smokers with no significant pre-existing ill health as judged following clinical screen by the study's research nurses. 19 participants completed each protocol. This was a non-CTIMP, un-blinded, dietary cross-over study, where participants experienced both treatments in random order. Two intervention meals were consumed by all participants on separate days: a vegetable based snack chip meal based on the snack chips of Example 4 (meal 1), and a minimally processed equivalent vegetable meal of Comparative Example 1 (meal 2). A wash-out period of at least 7 days was observed between each intervention meal and pre-menopausal women observed a longer wash-out, as each study day was initiated during the follicular phase of their menstrual cycle. As the trial was a controlled dietary bioavailability trial of compounds widely consumed in the diet, a number of dietary restrictions were placed on the subjects for 3 days prior to and during each test day to limit the intake of quercetin, apigenin, and glucoraphanin. After an overnight fast of at least 10 hours, a blood sample and spot urine were collected prior to the administration of the intervention meal.

After full consumption of the study meals, blood samples were collected at scheduled times considered a priori to be likely to coincide with known circulatory metabolites of quercetin, apigenin, and isothiocyanates. Likewise, urine was collected through the 24 hour period. The strategic design was made to collect urines into single aliquots (for each pass) between 0 and 6 hours and then as a combined ‘overnight’ pass from 6 to 24 hours. Compliance to urine sample collection (overnight) was registered via a standard case response form that was self-completed by the participant. All participants consented to consume a restricted diet for 3 days before each assessment visit, provide biological samples during each 24 h period of observation and consume each food treatment.

The human study assessed the comparative bioavailability of the snack food chips of Example 4 which included freeze-dried vegetables against frozen non-freeze dried vegetables served in a minimally processed manner (microwave steamed) according to Comparative Example 1. The microwave steamed method of cooking was chosen as the most likely to retain the bioactive compounds studied using IQF foods, prepared in a microwave steamer and with the leached condensate also consumed. The aim was to determine the extent to which quercetin, apigenin, and isothiocyaniates, and their metabolites, are bioavailable when consumed in a snack food product, in comparison with the bioavailability of a mixed vegetable meal containing broccoli, onion and parsley presented in similar proportions as prepared in the vegetable based snack food. To the inventors' knowledge, there are no published reports of human studies investigating the bioavailability of a mixed meal or vegetable based snack food containing a mixture of bioactives (quercetin, apigenin, and glucoraphanin).

There were however some differences between the two treatments provided. Comparing the snack product and mixed IQF vegetable meal, the analysis of the consumed meals showed that while glucoraphanin and quercetin content was similar (12.7 mg versus 12.6 mg respectively in the case of glucoraphanin and 33.1 mg versus 30.9 mg respectively in the case of quercetin), there was less apigenin (30.5 mg versus 48.2 mg respectively) in the snack product compared to the vegetable meal.

A primary assessment of quercetin, apigenin and glucoraphanin bioavailability was conducted in 24 h urine samples. The results are shown in Table 4 which shows the 24 hr urinary excretion of quercetin, apigenin and glucoraphanin metabolites in healthy adults after single-dose intake of a vegetable based snack food product or a minimally processed mixed vegetable meal.

TABLE 4

| | Vegetable meal | | | | |
|---|---|---|---|---|---|
| | (Comparative | | Snack food | | |
| | Example 1) | | (Example 4) | | Snack/ |
| | Mean | | Mean | | Vegetable |
| | (nmol) | SD | (nmol) | SD | % |
| Apigenin | 171.35 | 219.80 | 102.74 | 200.23 | 59.96 |
| Apigenin-7-glucoside | 9.92 | 15.92 | 4.70 | 11.49 | 47.37 |
| Apigenin-7-glucuronide | 256.97 | 319.43 | 192.78 | 248.38 | 75.02 |
| Isorhamnetin | 13.73 | 18.34 | 10.92 | 14.98 | 79.49 |
| Isorhamnetin-3- | 82.82 | 84.46 | 53.10 | 66.17 | 64.11 |
| glucuronide | | | | | |
| Quercetin | 22.22 | 41.36 | 11.25 | 24.05 | 50.65 |
| Quercetin-3-glucuronide | 136.45 | 77.81 | 138.14 | 110.66 | 101.24 |
| Quercetin-3-glucoside | 2.14 | 2.53 | 1.42 | 3.52 | 66.26 |
| Quercetin-3-sulfate | 104.23 | 54.87 | 85.28 | 61.46 | 81.82 |
| Sulforaphane | 550.90 | 556.92 | 460.35 | 353.81 | 83.56 |
| Sulforaphane-N-acetyl- | 6407.54 | 5681.33 | 3456.52 | 3566.07 | 53.94 |
| cysteine | | | | | |
| Total | | | | | 69.40 |

Table 5 shows 24 hr urinary excretion of quercetin, apigenin and glucoraphanin metabolites expressed in nmol per mg intake of the corresponding compound. Any statistical difference tested between the vegetable based snack food product and minimally processed vegetable meal used a paired t-test, with P<0.05.

TABLE 5

| | Vegetable meal | | Vegetable based | | | |
|---|---|---|---|---|---|---|
| | (Comparative | | snack food | | | |
| | Example 1) | | (Example 4) | | | |
| | Mean nmol/ | | Mean nmol/ | | Difference | |
| | mg intake | SD | mg intake | SD | (absolute) | P-value |
| Apigenin | 3.55 | 4.56 | 3.37 | 6.57 | 0.19 | 0.89 |
| Apigenin-7-glucoside | 0.21 | 0.33 | 0.00 | 0.38 | 0.05 | 0.37 |
| Apigenin-7-glucuronide | 5.33 | 6.63 | 6.32 | 8.14 | 0.99 | 0.55 |
| Isorhamnetin | 0.44 | 0.59 | 0.33 | 0.45 | 0.11 | 0.19 |
| Isorhamnetin-3-glucuronide | 2.67 | 2.72 | 1.60 | 2.00 | 1.07 | 0.02 |
| Quercetin | 0.72 | 1.33 | 0.34 | 0.73 | 0.38 | 0.12 |
| Quercetin-3-glucuronide | 4.40 | 2.51 | 4.17 | 3.34 | 0.23 | 0.75 |
| Quercetin-3-glucoside | 0.07 | 0.08 | 0.04 | 0.11 | 0.03 | 0.45 |
| Quercetin-3-sulfate | 3.36 | 1.77 | 2.58 | 1.86 | 0.79 | 0.10 |
| Sulforaphane | 43.72 | 44.20 | 36.25 | 27.86 | 7.47 | 0.42 |
| Sulforaphane-N-acetyl- | 508.54 | 450.90 | 272.17 | 280.79 | 236.4 | 0.06 |
| cysteine | | | | | | |

The experimental results of these Examples, as compared to Comparative Example 1, show that a new snack food production technique which utilizes the inclusion of freeze-dried vegetable materials into a snack food product, has the potential to deliver similar absolute circulatory levels of flavonoids and isothiocyanates as a substantially larger meal of 461 gr of vegetables in just 75 g of snack food chips. The cooked mixed vegetable meal provided approximately 5.75 equivalent portions of vegetables (at 80 gr per portion) and, on the basis of the flavonoids and isothiocyanates assessed, and the snack food product provided statistically similar amounts in vivo.

These results suggest that utilizing freeze-dried vegetable materials allows the production of snack foods in the form of chips, containing substantial amounts of vegetables and good retention of their bioactives which may have bioequivalence with lightly cooked vegetables and could provide a means to further increase the intake of bioactive compounds in the consumer diet.

These experimental procedures tested recipes and methods to produce a snack containing different vegetables and herbs that incorporate significant amounts of bioactives glucoraphanin and flavanols (quercetin and apigenin). The results demonstrated that the incorporation of freeze-dried vegetables into a snack food, particularly a dough for forming a chip, such as a baked chip, allows the production of snacks containing substantial amounts of bioactives. The in vitro studies investigated the bioaccessibility and absorption from the gut, and predicted that there would be little difference in bioavailability between the snack and a mixed of vegetables for flavonoids and glucosilonates. These predictions were supported by a human bioavailability study that could detect the appearance of flavonoids and isothiocyanates conjugates for glucosinolates.

Various other modifications to the present invention, as defined in the appended claims, will be readily apparent to those skilled in the art.

1.-87. (canceled)

88. A method of making a snack food in the form of snack food chips, the method comprising the steps of:
a. providing at least one pre-processed vegetable material, the pre-processed vegetable material including at least one bioactive component which comprises a polyphenol or a glucosinolate or a mixture of any two or more thereof, wherein the at least one pre-processed vegetable material is in a freeze-dried form, in an individually quick frozen (QF) form, hi a defrosted, chilled or fresh comminuted form and/or in a defrosted, chilled or fresh pulp form;
b. incorporating the at least one pre-processed vegetable material into a dough, wherein the dough is a potato-based dough, and wherein the dough forms individual dough sheet portions, and the snack food is in the form of snack food chips;
c. cooking the dough sheet portions to form a cooked snack food in the form of snack food chips, the cooked snack food having a moisture content after the cooking step of from 5 to 25 wt % based on the weight of the cooked snack food, wherein the cooking comprises baking, microwave cooking, infra-red cooking or radio frequency (F) cooking; and
d. drying the cooked snack food to form a dried snack food which has a moisture content after the drying step of from 1 to 4 wt %, based on the weight of the dried cooked snack food.

89. The method according to claim 88 wherein the dough comprises from 2 to 50 wt % of the at least one pre-processed vegetable material, which includes a bioactive component which comprises a flavanol, a flavone, and/or a glucosinolate, on a dry material basis.

90. The method according to claim 89 where the at least one pre-processed vegetable material includes a bioactive component which comprises (i) a flavanol and comprises a vegetable or herb selected from onion, red onion, spring onion, capers, capsicum pepper, serrano pepper, chilli pepper, hot wax pepper, ancho pepper, fennel, radish, radicchio, kale, chive, dill, lovage, sorrel, coriander, tarragon, watercress, corn poppy, buckwheat, or sweet potato, or any mixture of any two or more thereof, and/or (ii) a flavone and comprises a vegetable or herb selected from artichoke, celery, celeriac, spinach, basil, coriander, oregano, parsley, rosemary, or thyme, or any mixture of two or more thereof, and/or (iii) a glucosinolate and is selected from brussels sprout, cabbage, savoy cabbage, red cabbage, kale, kohlrabi, pakchoi, horseradish, wasabi, broccoli, cauliflower, turnip, watercress, green mustard, or cress, or any mixture of any two or more thereof.

91. The method according to claim 90 wherein the snack food comprises from 20 to 100 mg of the flavanol per 100 g of the snack food on a dry material basis.

92. The method according to claim 91 wherein the snack food comprises from 30 to 50 mg of the flavone per 100 g of the snack food on a dry material basis.

93. The method according to claim 92 wherein the snack food comprises from 10 to 75 mg of the glucosinolate per 100 g of the snack food on a dry material basis.

94. The method according to claim 93 wherein the potato-based dough comprises from 10 to 80 wt % potato on a dry material basis.

95. A method according to claim 88 wherein the cooking comprises a first step in which a single layer of dough is cooked and dried to a first moisture content to form a partly cooked food slice and the drying comprises a second step in which a bed comprising a stack of a plurality of the partly cooked food slices is dried from the first moisture content to a lower second moisture content.

96. The method according to claim 95 wherein the first step has a moisture removal rate of from 1×10⁻³ to 10×10⁻³ g water/g solids/sec, and/or the second step has a moisture removal rate of from 1×10⁻⁵ to 10×10⁻⁴ g water/g solids/sec, and/or the average moisture removal rate during the combination of the cooking and drying steps is from 1×10⁻⁴ to 10×10⁻⁴ g water/g solids/sec.

97. The method according to claim 94 claim wherein the at least one bioactive component, which comprises a polyphenol or a glucosinolate or a mixture of any two or more thereof, is present hi a concentration of at least 5 mg per 100 g of the snack food on a dry material basis.

98. The method according to claim 97 wherein the snack food comprises at least one of (i) from 20 to 100 mg, or from 30 to 50 mg, of a flavanol polyphenol per 100 g of the snack food snack food on a dry material basis; (ii) from 15 to 150 mg, or from 30 to 50 mg, of the flavone polyphenol per 100 g of the snack food on a dry material basis; and/or (iii) from 10 to 75 mg, or from 15 to 50 mg, of the glucosinolate per 100 g of the snack food on a dry material basis.

99. A food composition comprising the snack food chip according to claim 88.

100. A snack food chip comprising vegetable material including at least one bioactive component which comprises a polyphenol or a glucosinolate or a mixture of any two or more thereof, wherein the at least one bioactive component is present in a concentration of at least 5 mg per 100 g of the snack food chip on a dry material basis.

101. The snack food chip according to claim 100 wherein the snack food chip comprises from 2 to 50 wt % of the vegetable material on a dry material basis.

102. The snack food chip according to claim 101 wherein the snack food chip comprises from 10 to 80 wt % potato on a dry material basis.

103. The snack food chip according to claim 102 wherein the bioactive component comprises a flavanol, a flavone, a glucosinolate, and mixtures thereof.

104. The snack food chip according to claim 103 wherein the snack food snack food chip comprises from 20 to 100 mg of the flavanol per 100 g of the snack food snack food chip on a dry material basis, from 15 to 150 mg, of the flavone per 100 g of the snack food chip on a dry material basis, and from 10 to 75 mg of the glucosinolate per 100 g of the snack food chip on a dry material basis.

105. The snack food chip according to claim 104 wherein the flavonal is quercetin, the flavone is apigenin, and the glucosinolate is glucoraphanin.

106. The snack food chip according to claim 100 wherein the snack food chip has a moisture content of from 1 to 4 wt %.
